(19) United States
(12) Patent Application Publication
(10) Pub. No.: US 2007/0205872 A1
(43) Pub. Date: Sep. 6, 2007

(54) LOW-POWER WIRELESS COMMUNICATION APPARATUS AND METHOD

(75) Inventors: Jeong Hoon Kim, Kyungki-Do (KR); Tah Joon Park, Kyungki-Do (KR); Ji Hoon Kim, Kyungki-Do (KR); Eung Jun Kim, Kyungki-Do (KR); Joong Jin Kim, Kyungki-Do (KR); Dong Ok Han, Kyungki-Do (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/566,608

(22) Filed: Dec. 4, 2006

(30) Foreign Application Priority Data
Feb. 20, 2006 (KR) 10-2006-0016310

(51) Int. Cl. H04Q 5/22

(52) U.S. Cl. 340/10.33; 455/343.1; 370/311; 340/7.36; 455/522

(57) ABSTRACT

Provided is a low-power wireless communication apparatus and method. In the apparatus, a low-noise amplifier amplifies an RF signal in an on state, the low-noise amplifier be turned on/off according to a predetermined control signal. A wake-up signal detector detects a wake-up signal from the amplified RF signal. A controller provides the predetermined control signal such that the low-noise amplifier and the wake-up signal detector operate at a predetermined on-off duty ratio in a sleep mode corresponding to an Rx waiting state, and switching to an Rx mode to maintain the on state of the low-noise amplifier when the wake-up signal is detected.

### RELATED APPLICATION

The present application is based on, and claims priority from, Korean Application Number 2006-16310, filed on 20 Feb. 2006, the disclosure of which is hereby incorporated by reference herein in its entirety.

### BACKGROUND OF THE INVENTION

1. Field of the Invention

The present invention relates to a low-power wireless communication apparatus and method in which a wireless communication operation is performed according to a wake-up signal, and more particularly, to a low-power wireless communication apparatus and method in which a wireless communication operation can be performed at the minimum power by controlling the detection of a wake-up signal in a sleep mode according to an on-off duty ratio.

2. Description of the Related Art

Most of wireless devices for communication systems are portable devices using a battery as a power source. Thus, many efforts have been made to reduce unnecessary power consumption in order to expand the life span of the battery.

To this end, an event driven scheme and a time driven scheme are proposed. According to the event driven scheme, the wireless communication device is maintained in a receive (Rx) waiting state and then operates in response to an external wake-up signal. According to the time driven scheme, the wireless communication device is maintained in an Rx waiting state for a predetermined time and then checks a channel at a specific time.

The event driven scheme using the wake-up signal is very effective in an area where the density of waves having the same frequency band is low. However, an unnecessarily large number of transmitting/receiving parts operate in an area where the density of waves having the same frequency band is high, the event driven scheme is ineffective in terms of power consumption. On the contrary, the time driven scheme is ineffective even in an area where the density of waves having the same frequency band is low. In order to solve the problems, a wireless communication device using the event driven scheme and the time driven scheme in a combined manner has been proposed.

Hereinafter, a conventional wireless communication device that uses the event driven scheme and the time driven scheme in a combined manner will be described in detail.

FIG. 1 is a block diagram of a conventional low-power wireless communication device.

Referring to FIG. 1, the conventional wireless communication device includes an antenna 101, a switch 102, an RF-DC converter 103, an RF receiver 104, an RF oscillator 105, an RF transmitter 106, a baseband processor 107, and a controller 108. The antenna 101 transmits and receives radio-frequency (RF) signals. The switch 102 is used to selectively connect the antenna 101. The RF-DC converter 103 converts the received RF signal into a direct-current (DC) signal. The RF receiver 104, the RF oscillator 105 and the RF transmitter 106 are used to transmit/receive RF signals. The baseband processor 107 processes a received RF signal. According to the operation modes of the wireless communication device, the controller 108 controls the connection of the switch 102 and the operations of the RF-DC converter 103, the RF receiver 104, the RF oscillator 105, the RF transmitter 106 and the baseband processor 107.

In a sleep mode corresponding to an Rx waiting state, the switch 102 connects to the RF-DC converter 103, and the RF-DC converter 103 coverts an input RF signal into a DC signal to detect a wake-up signal. Upon detection of the wake-up signal, the wireless communication device transmits an advertisement signal through the RF transmitter 106 in order to detect whether the detected wake-up signal is a desired signal. Upon receipt of a valid response to the advertisement signal, the wireless communication device starts to transmit data. Upon completion of the data transmission, the wireless communication device switches to a sleep mode. If a response to the advertisement signal is not received within a predetermined time or if a received response to the advertisement signal is invalid, the wireless communication device determine that no wake-up signal is received and switches to a sleep mode.

As described above, the conventional method is characterized in that it uses an event driven scheme and a time driven scheme in a combined manner. In detail, an event driven scheme using a wake-up signal is mainly used in radio environments with a low in-band frequency density and a time driven scheme is mainly used in radio environments with a low frequency density, so that a low-power communication operation is possible in any radio environment.

The conventional method is advantageous in that the system is relatively simple and efficient. On the other hand, the conventional system is inefficient in power consumption because the switch 102, the RF-DC converter 103, the RF receiver 104, the RF oscillator 105, the RF transmitter 106 and the baseband processor 107 must be supplied with power for operation to detect a wake-up signal and to determine whether the detected wake-up signal is a desired signal. That is, the RF transmitter 106, the RF receiver 104, the RF oscillator 105 and the baseband processor 107 are all driven during the Tx/Rx operation of an advertisement signal so as to determine whether the detected wake-up signal is a valid signal or a signal caused by interference with other devices. This causes a waste of power, leading to a decrease in the usable duration of a battery. The usable duration of the battery further decreases when the number of devices sharing the same frequency band increases.

### SUMMARY OF THE INVENTION

Accordingly, the present invention is directed to a low-power wireless communication apparatus and method that substantially obviates one or more problems due to limitations and disadvantages of the related art.

An object of the present invention is to provide a low-power wireless communication apparatus and method that enables a communication operation to be performed at the minimum power.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a low-power wireless communication apparatus including: a low-noise amplifier for amplifying an RF signal in an on state, the low-noise amplifier be turned on/off according to a predetermined control signal; a wake-up signal detector for detecting a wake-up signal from the amplified RF signal; and a controller for providing the predetermined control signal such that the low-noise amplifier and the wake-up signal detector operate at a predetermined on-off duty ratio in a sleep mode corresponding to an Rx waiting state, and switching to an Rx mode to maintain the on state of the low-noise amplifier when the wake-up signal is detected.

In an embodiment of the present invention, the on-off duty ratio of the low-noise amplifier is automatically set depending on communication environments.

In another embodiment of the present invention, the low-power wireless communication further includes: a receiver for receiving the amplified RF signal of the low-noise amplifier in the Rx mode; and a first switch for selectively connecting the low-noise amplifier to one of the wake-up signal detector and the receiver, wherein the controller controls the first switch such that the low-noise amplifier is connected to the wake-up signal detector in the sleep mode and is connected to the receiver in the Rx mode.

In a further another embodiment of the present invention, the low-power wireless communication apparatus further includes: a transmitter for transmitting an RF signal in a Tx mode; an antenna for transmitting/receiving the RF signal; and a second switch for selectively connecting the antenna to one of the low-noise amplifier and the transmitter, wherein the controller controls the second switch such that the antenna is connected to the low-noise amplifier in the sleep mode and the Rx mode and is connected to the transmitter in the Tx mode.

In a still further embodiment of the present invention, the controller determines whether the RF signal received by the receiver is valid, switches to the sleep mode if the RF signal is invalid, controls the Tx/Rx operation of the RF signal if the RF signal is valid, and switches to the sleep mode after completion of the Tx/Rx operation of the RF signal.

In an even further embodiment of the present invention, the controller maintains an off mode during a predetermined time before switching to the sleep mode, where the low-noise amplifier, the wake-up signal detector and the receiver are in an off state at the off mode.

In a yet further embodiment of the present invention, the wake-up signal detector comprises: a high-gain amplifier for re-amplifying the amplified RF signal of the low-noise amplifier; a rectifier for rectifying the re-amplified RF signal; an integrator for integrating the rectified RF signal; and a comparator for generating a wake-up detection signal if the integrated RF signal exceeds a predetermined threshold point.

According to an aspect of the present invention, there is provided a low-power wireless communication apparatus including: an antenna for transmitting/receiving an RF signal; a low-noise amplifier for amplifying an RF signal from the antenna in an on state, the low-noise amplifier be turned on/off according to a predetermined control signal; a wake-up signal detector for detecting a wake-up signal from the amplified RF signal; a receiver for receiving the amplified RF signal of the low-noise amplifier in an Rx mode; a transmitter for transmitting an RF signal in a Tx mode; a first switch for selectively connecting the low-noise amplifier to one of the wake-up signal detector and the receiver; a second switch for selectively connecting the antenna to one of the low-noise amplifier and the transmitter; and a controller for providing the predetermined control signal such that the low-noise amplifier operates at a predetermined on-off duty ratio in a sleep mode corresponding to an Rx waiting state, and switching to the Rx mode to maintain the on state of the low-noise amplifier when the wake-up signal is detected, wherein the controller controls the first switch and the second switch such that the antenna is connected to the low-noise amplifier and the wake-up signal detector in the sleep mode; that the antenna is connected to the low-noise amplifier and the receiver in the Rx mode; and the antenna is connected to the transmitter in the Tx mode.

According to another aspect of the present invention, there is provided a low-power wireless communication method including the steps of: receiving and amplifying an RF signal at a predetermined on-off duty ratio in a sleep mode corresponding to an Rx waiting state; detecting a wake-up signal from the amplified RF signal; determining the validity of the wake-up signal; transmitting the RF signal if the wake-up signal is valid; and switching to the sleep mode after completion of the transmission/reception of the RF signal.

In an embodiment of the present invention, the low-power wireless communication method further includes the step of setting the predetermined on-off duty ratio depending on communication environments.

In another embodiment of the present invention, the step of detecting the wake-up signal from the amplified RF signal comprises the steps of: detecting the wake-up signal; rectifying the amplified RF signal; integrating the rectified RF signal; and comparing the integrated RF signal with a predetermined threshold point.

In a further another embodiment of the present invention, the validity of the wake-up signal is determined by receiving data after the detection of the wake-up signal.

In a still further embodiment of the present invention, the low-power wireless communication method further includes the step of switching to the sleep mode if the wake-up signal is invalid.

In an even further embodiment of the present invention, the low-power wireless communication method further includes the step of switching to an off mode where an off state is maintained during a predetermined time before the switching to the sleep mode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a conventional low-power wireless communication device;

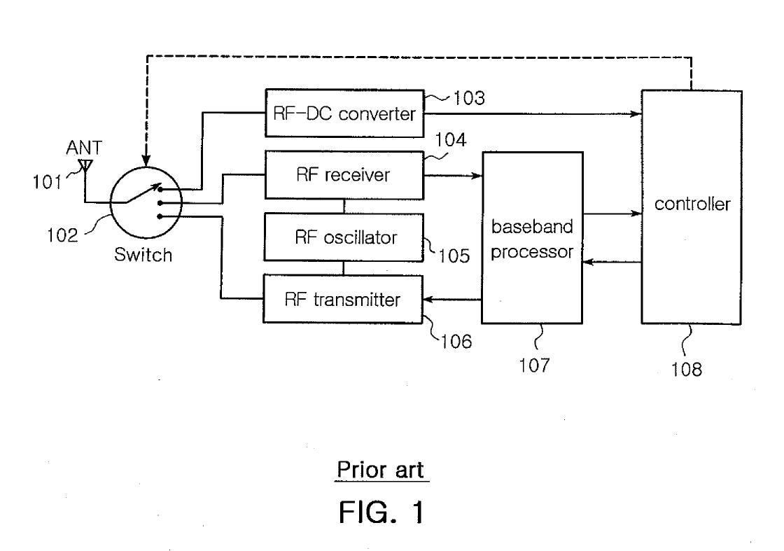

FIG. 2 is a block diagram of a low-power wireless communication apparatus according to an embodiment of the present invention;

FIG. 3 illustrates a block diagram and an operational waveform diagram of a wake-up signal detector according to an embodiment of the present invention;

FIG. 4 is a flowchart illustrating a low-power wireless communication method according to an embodiment of the present invention;

FIG. 5 is a diagram illustrating an operating state of the low-power wireless communication in each mode according to an embodiment of the present invention;

FIG. 6 is a diagram illustrating the power consumption of the low-power wireless communication apparatus according to a valid wake-up signal; and

FIG. 7 is a diagram illustrating the power consumption of the low-power wireless communication apparatus according to an invalid wake-up signal.

### DETAILED DESCRIPTION OF THE INVENTION

Reference will now be made in detail to the preferred embodiments of the present invention, examples of which are illustrated in the accompanying drawings.

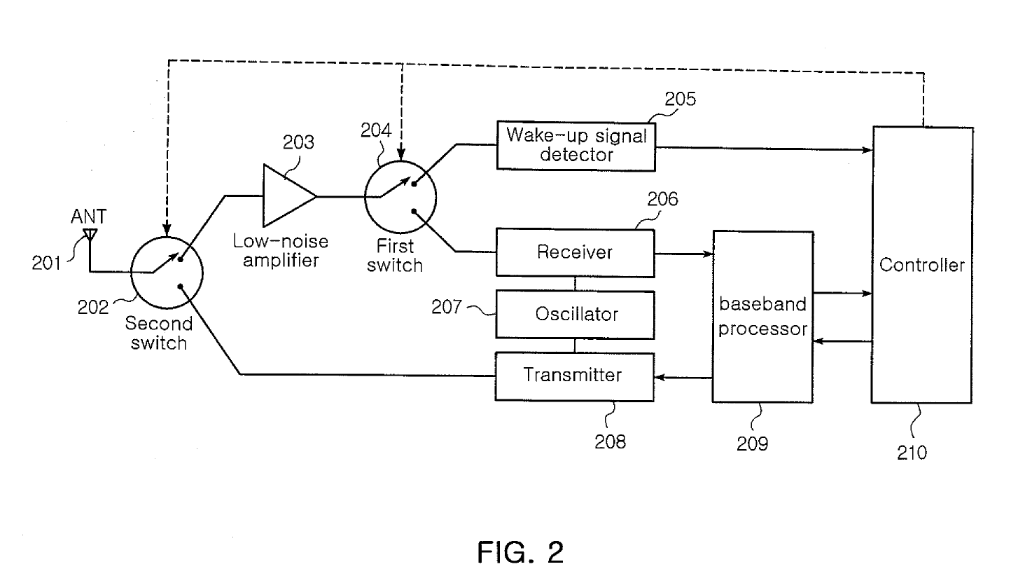

FIG. 2 is a block diagram of a low-power wireless communication apparatus according to an embodiment of the present invention.

Referring to FIG. 2, the low-power wireless communication apparatus includes an antenna 201, a second switch 202, a low-noise amplifier (LNA) 203, a first switch 204, a wake-up signal detector 205, a receiver 206, an oscillator 207, a transmitter 208, a baseband processor 209, and a controller 210. The antenna 201 transmits and receives radio-frequency (RF) signals. The low-noise amplifier 203 amplifies an RF signal received through the antenna 201. The wake-up signal detector 205 detects a wake-up signal from the amplified RF signal. The receiver 206 receives an RF signal, the oscillator 207 generates a carrier signal, and the transmitter 208 transmits an RF signal. The baseband processor 209 processes a received RF signal. The second switch 202 selectively connects the antenna 201 to the low-noise amplifier 203 or the transmitter 208. The first switch 204 selectively connects the low-noise amplifier 203 to the wake-up signal detector 205 or the receiver 206. The controller 210 controls the operations of the low-noise amplifier 203, the receiver 206, the oscillator 207, the transmitter 208 and the baseband processor 209.

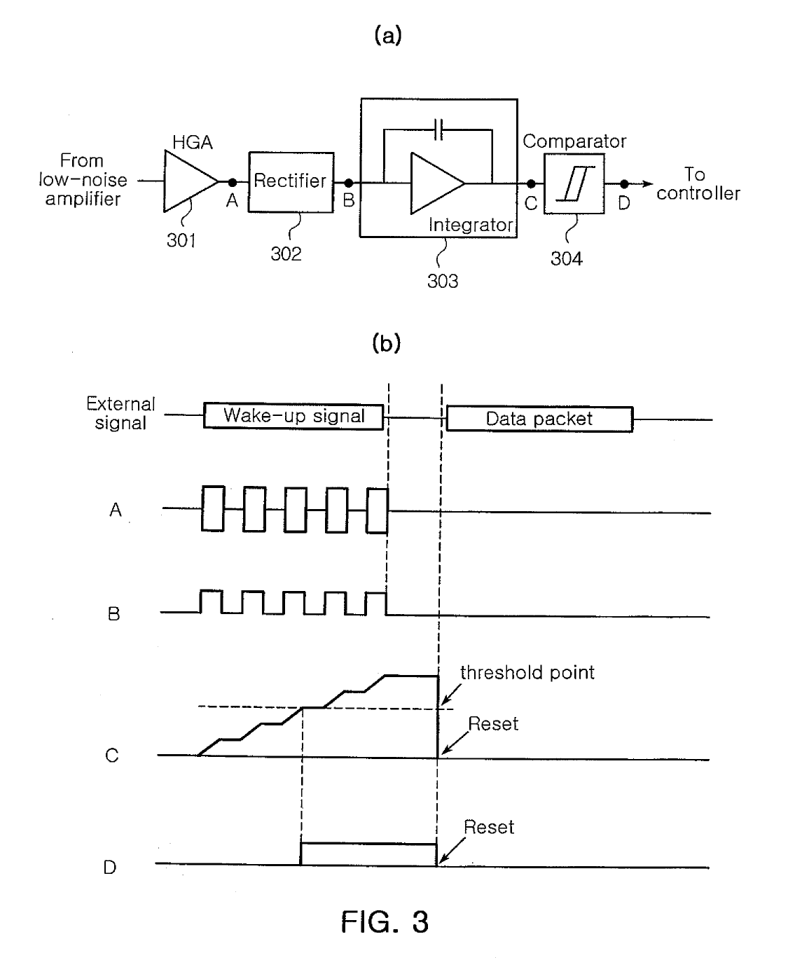

FIG. 3(a) is a block diagram of the wake-up signal detector 205 according to an embodiment of the present invention.

Referring to FIG. 3(a), the wake-up signal detector 205 includes a high-gain amplifier (HGA) 301, a rectifier 302, an integrator 303, and a comparator 304. The high-gain amplifier 301 amplifies an RF signal output from the low-noise amplifier 203, the rectifier 302 rectifies the amplified RF signal, and the integrator 303 integrates the rectified RF signal. When the integrated RF signal exceeds a predetermined threshold point, the comparator 304 outputs a signal indicating detection of a wake-up signal.

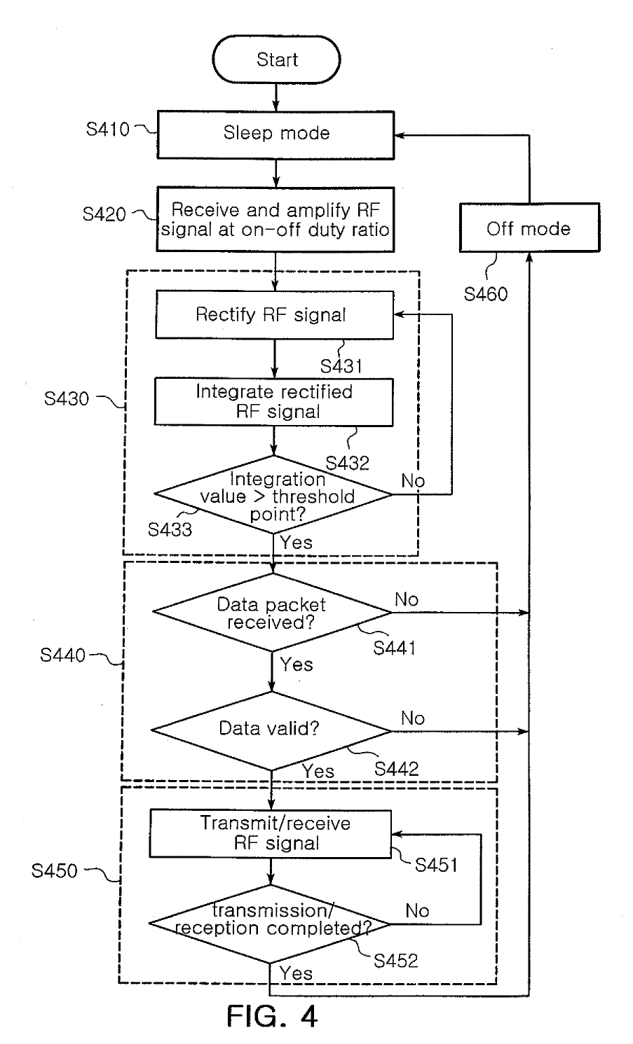

FIG. 4 is a flowchart illustrating a low-power wireless communication method according to an embodiment of the present invention.

Referring to FIG. 4, the low-power wireless communication method includes; the step of a sleep mode (S410); the step of receiving and amplifying an RF signal at an on-off duty ratio (S420); the step of detecting a wake-up signal from the amplified RF signal (S430); the step of determining the validity of the wake-up signal (S440); the step of transmitting/receiving an RF signal (S450); and the step of switching to a sleep mode upon completion of the transmitting/receiving step (S452).

Hereinafter, the operation and effect of the present invention will be described in detail with reference to the accompanying drawings.

Referring to FIG. 2, the low-noise wireless communication apparatus according to the present invention operates in a sleep mode corresponding to an Rx waiting state, in an Rx mode for receiving an RF signal, and in a Tx mode for transmitting an RF signal.

In the sleep mode, the controller 210 controls the first switch 204 and the second switch 202 to connect the antenna 201, the low-noise amplifier 203 and the wake-up signal detector 205, such that a signal path is established to supply a signal received from the antenna 201 through the low-noise amplifier 203 to the wake-up signal detector 205. The low-power wireless communication apparatus detects a wake-up signal from a signal received from the antenna in a sleep mode. At this point, the remaining components other than the controller 210, the low-noise amplifier 203 and the wake-up signal detector 205, which are related to the detection of the wake-up signal, are turned off, and the low-noise amplifier 203 is turned on/off at a predetermined on/off duty ratio. The controller 210 controls the on/off operation of the low-noise amplifier 203.

The wake-up signal detector 205 detects a wake-up signal from the amplified RF signal of the low-noise amplifier 203. Upon receipt of the wake-up signal, the wake-up signal detector 205 generates a signal indicating the detection of the wake-up signal (hereinafter, referred to as “wake-up detection signal”) and provides the wake-up detection signal to the controller 210.

Referring to FIG. 3(a), the amplified RF signal of the low-noise amplifier 203 is re-amplified by the high-gain amplifier 301. The re-amplified RF signal is rectified by the rectifier 302, and the rectified RF signal is integrated by the integrator 303. If the integrated RF signal exceeds a predetermined threshold point, the comparator 304 generates the wake-up detection signal and provides the same to the controller 210. At this point, the high-gain amplifier 301 as well as the low-noise amplifier 203 is turned on/off at a predetermined on-off duty ratio.

FIG. 3(b) is an operational waveform diagram of the wake-up signal detector 205 according to an embodiment of the present invention.

The conventional wireless communication device converts an RF signal of the RF-DC converter 103 into a DC signal. If the DC signal exceeds a predetermined threshold point, the conventional wireless communication device terminates a sleep mode and switches to a Tx/Rx mode. Therefore, the conventional wireless communication device determines a noise signal or signals for other wireless devices to be the wake-up signal, and turns on the RF transmitter 106, the RF receiver 104, etc. This causes unnecessary power consumption.

On the other hand, in the low-power wireless communication apparatus according to the present invention, the low-noise amplifier and the wake-up signal detector are not turned on continuously but are turned on/off at a predetermined on/off cycle. For example, when the on/off duty ratio is 50%, the power consumption in the sleep mode is smaller by 50% than the conventional art.

In addition, when an RF signal is detected by the wake-up signal detector, the low-power wireless communication apparatus does not directly switch from the sleep mode to the Rx/Tx mode consuming a lower power. The low-power wireless communication apparatus switches from the sleep mode to the other modes consuming a lower power only when the integrated RF signal exceeds the predetermined threshold point. Accordingly, the sleep mode is maintained over the external noise signals, thereby reducing the unnecessary power consumption.

In an embodiment of the present invention, the on-off duty ratio of the low-noise amplifier 203 and the wake-up signal detector 205 may vary and may be automatically set depending on communication environments. For example, if received RF signals are many, the on duty may be larger; and if received RF signals are few, the on duty may be smaller.

When a wake-up signal is detected by the wake-up signal detector 205, the controller 210 switches to an Rx mode. The controller 210 controls the first switch 204 and the second switch 202 to connect the antenna 201, the low-noise amplifier 203 and the receiver 206. Accordingly, a signal path is established such that a signal from the antenna 201 is supplied through the low-noise amplifier 203 to the receiver 206.

After the wake-up signal is detected, it must be determined whether the received wake-up signal is a valid wake-up signal. To this end, the conventional wireless communication device switches from a sleep mode to a Tx mode, transmits an advertisement signal, receives a response to the advertisement signal, and determines whether the response is valid. In this case, a large amount of power is required for the transmission of the advertisement signal and the reception of the response thereto.

On the other hand, when the wake-up signal is detected, the low-power wireless communication apparatus switches from a sleep mode to an Rx mode, turns on the low-noise amplifier 203, the receiver 206, the oscillator 207 and the baseband processor 209, and turns off the wake-up signal detector 205 and the transmitter 208. In the Rx mode, the low-power wireless communication apparatus receives a data packet for checking the validity of the detected wake-up sign. If the data packet is not received within a predetermined time or if the received data packet is invalid, the low-power wireless communication apparatus terminates the Rx mode and switches to the sleep mode. If the data packet is valid, the low-power wireless communication apparatus determines that the wake-up signal is valid and transmits/receives RF signals to/from an external device (not illustrated).

The conventional wireless communication device transmits the advertisement signal, receives the response thereto, and analyzes the received response for determining the validity of the wake-up signal. Unlike the conventional wireless communication device, the low-power wireless communication apparatus receives the data packet directly without transmission of the advertisement signal and analyzes the received data packet for determining the validity of the wake-up signal, thereby making it possible to reduce the power consumption due to the transmission of the advertisement signal.

In the Tx mode, the controller 210 controls the second switch 202 to connect the antenna 201 and the transmitter 208, turns on the transmitter 208, the oscillator 207, the baseband processor 209, and turns off the low-noise amplifier 203, the wake-up signal detector and the receiver 206.

Upon completion of the Tx operation, the low-power wireless communication apparatus switches form the Tx mode to the sleep mode.

In an embodiment of the present invention, the remaining components other than the controller 210 are in an off mode, and the controller 210 is maintained at an off mode during a predetermined time before the switching to the sleep mode. As described above, if the detected wake-up signal is invalid or if the data Tx/Rx operations are completed, the low-power wireless communication apparatus switched to the sleep mode. When the off mode is maintained during the predetermined time before the switching to the sleep mode, the power consumption can be further reduced.

The duration of the off mode may vary depending on communication environments. In an embodiment of the present invention, the controller 210 may detect communication environments to automatically adjust the duration of the off mode. For example, if received RF signals are many, the duration of the off mode may be set to be relatively short.

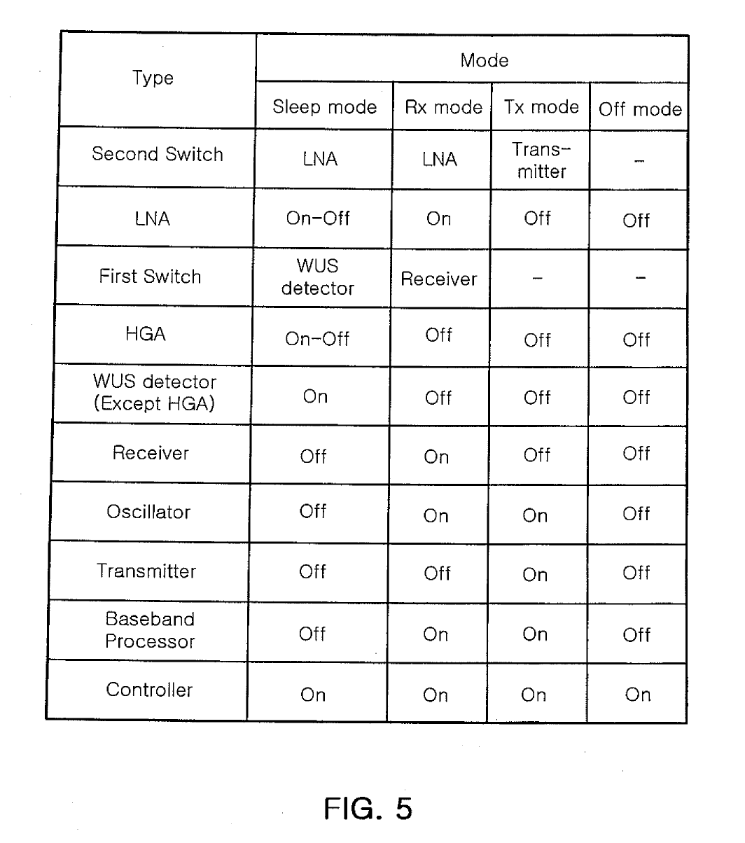

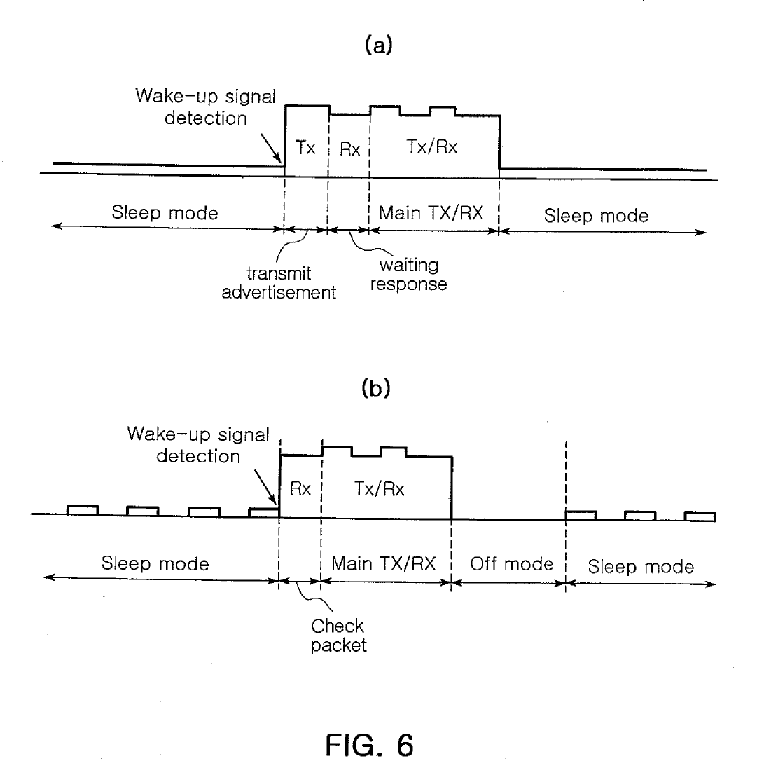

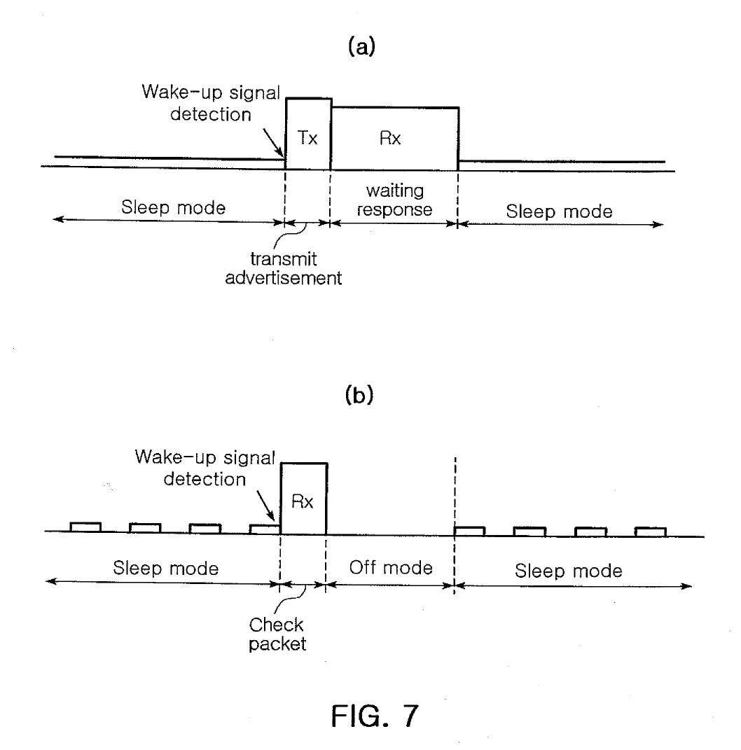

FIG. 5 is a diagram illustrating an operating state of the low-power wireless communication in each mode according to an embodiment of the present invention. FIGS. 6 and 7 are diagrams illustrating the power consumption of the low-power wireless communication apparatus according to a valid wake-up signal and an invalid wake-up signal according to the related art and the present invention.

Referring to FIGS. 5 to 7, the low-noise amplifier and the high-gain amplifier of the wake-up signal detector performs the on-off operation, omits the advertisement transmission for checking the validity of the wake-up signal, and maintains the off mode for a predetermined time when the operation mode is switched to the sleep mode. Therefore, compared with the related art, the power consumption of the wireless communication apparatus according to the present invention can be reduced much more.

Hereinafter, the operation and effect of a low-power wireless communication method according to the present invention will be described in detail with reference to FIG. 4.

Referring to FIG. 4, the wireless communication method according to an embodiment of the present invention starts in a sleep mode in step S410. In step S420, the wireless communication apparatus is in a waiting state in the sleep mode, and receives and amplifies an RF signal according to an on-off duty.

The wireless communication method may further include the step of automatically setting the on-off duty, depending on a wireless communication operation environment. Preferably, the on-off duty is automatically set, depending on the communication environment. For example, when a large amount of the RF signal is received, the on duty may be set to be relatively large. On the other hand, when a small amount of the RF signal is received, the on duty may be set to be relatively small. Therefore, the power consumption can be reduced in the sleep mode by amplifying the RF signal according to the on-off duty.

In step S430, the wake-up signal is detected from the amplified RF signal. The step S430 of detecting the wake-up signal may include the steps of: rectifying the amplified RF signal (S431); integrating the rectified RF signal (S432); and comparing the integrated RF signal with the threshold point (S433). When the integrated RF signal exceeds the threshold point in step S433, it is determined that the wake-up signal is detected and then the process proceeds to a next step. Through the step of rectifying and integrating the received RF signal, the instant signal such as an external noise is not recognized as the wake-up signal. Thus, it is possible to reduce the unnecessary power consumption that has been caused by the step of recognizing the external noise as the wake-up signal and determining the validity.

When the wake-up signal is detected in step S433, it is determined in step S440 if the wake-up signal is a valid signal. After detecting the wake-up signal, data packet is received in step S441 and it is determined if the received data packet is valid in step S442. When the received data packet is valid in step S442, the process proceeds to a next step. When no data packet is received in step S441 or the received packet is invalid in step S442, it is determined that the wake-up signal is invalid and the operation mode is switched to the sleep mode in step S410. Because the step of transmitting the advertisement is omitted, the power necessary for the advertisement transmission can be saved.

When the received data packet is valid in step S442, the RF signal is transmitted/received in step S451. When the transmission/reception of the RF signal is completed, the operation mode is switched to the sleep mode in step S410.

Before the operation mode is switched to the sleep mode in steps S441 and S442, the wireless communication method according to the present invention may further include the step of switching the operation mode to an off mode of maintaining an off state for a predetermined time (S460). Preferably, the predetermined time can be differently set, depending on the communication environment. After the transmission/reception of the RF signal are completed, it is usual that the communication does not occur for a predetermined time. Therefore, unnecessary power consumption can be reduced by setting the off mode after the transmission/reception are completed.

According to the present invention, because the low-noise amplifier and the wake-up signal detector perform the on-off operations in the sleep mode according to the on-off duty, the power consumption can be reduced.

In addition, after the wake-up signal is detected, the data packet is received and the validity of the wake-up signal is determined. Thus, because the step of transmitting the advertisement in order to determine the wake-up signal can be omitted, the power consumption necessary for this step can be saved.

Moreover, prior to the switch to the sleep mode after the transmission/reception is completed or the wake-up signal is determined as being invalid, all units other than the controller are set to the off state. Therefore, the power consumption can be further reduced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A low-power wireless communication apparatus comprising:
a low-noise amplifier for amplifying an RF signal in an on state, the low-noise amplifier being turned on/off according to a predetermined control signal;
a wake-up signal detector for detecting a wake-up signal from the amplified RF signal; and
a controller for providing the predetermined control signal such that the low-noise amplifier and the wake-up signal detector operate at a predetermined on-off duty ratio in a sleep mode corresponding to an Rx waiting state, and switching to an Rx mode to maintain the on state of the low-noise amplifier when the wake-up signal is detected.

2. The low-power wireless communication apparatus of claim 1, wherein the on-off duty ratio of the low-noise amplifier is automatically set depending on communication environments.

3. The low-power wireless communication apparatus of claim 1, further comprising:
a receiver for receiving the amplified RF signal of the low-noise amplifier in the Rx mode; and
a first switch for selectively connecting the low-noise amplifier to one of the wake-up signal detector and the receiver,
wherein the controller controls the first switch such that the low-noise amplifier is connected to the wake-up signal detector in the sleep mode and is connected to the receiver in the Rx mode.

4. The low-power wireless communication apparatus of claim 3, further comprising:
a transmitter for transmitting an RF signal in a Tx mode;
an antenna for transmitting/receiving the RF signal; and
a second switch for selectively connecting the antenna to one of the low-noise amplifier and the transmitter,
wherein the controller controls the second switch such that the antenna is connected to the low-noise amplifier in the sleep mode and the Rx mode and is connected to the transmitter in the Tx mode.

5. The low-power wireless communication apparatus of claim 3, wherein the controller determines whether the RF signal received by the receiver is valid, switches to the sleep mode if the RF signal is invalid, controls the Tx/Rx operation of the RF signal if the RF signal is valid, and switches to the sleep mode after completion of the Tx/Rx operation of the RF signal

6. The low-power wireless communication apparatus of claim 5, wherein the controller maintains an off mode during a predetermined time before switching to the sleep mode, where the low-noise amplifier, the wake-up signal detector and the receiver are in an off state at the off mode.

7. The low-power wireless communication apparatus of claim 1, wherein the wake-up signal detector comprises:
a high-gain amplifier for re-amplifying the amplified RF signal of the low-noise amplifier;
a rectifier for rectifying the re-amplified RF signal;
an integrator for integrating the rectified RF signal; and
a comparator for generating a wake-up detection signal if the integrated RF signal exceeds a predetermined threshold point.

8. A low-power wireless communication apparatus comprising:
an antenna for transmitting/receiving an RF signal;
a low-noise amplifier for amplifying an RF signal from the antenna in an on state, the low-noise amplifier being turned on/off according to a predetermined control signal;
a wake-up signal detector for detecting a wake-up signal from the amplified RF signal;
a receiver for receiving the amplified RF signal of the low-noise amplifier in an Rx mode;
a transmitter for transmitting an RF signal in a Tx mode;
a first switch for selectively connecting the low-noise amplifier to one of the wake-up signal detector and the receiver;
a second switch for selectively connecting the antenna to one of the low-noise amplifier and the transmitter; and
a controller for providing the predetermined control signal such that the low-noise amplifier operates at a predetermined on-off duty ratio in a sleep mode corresponding to an Rx waiting state, and switching to the Rx mode to maintain the on state of the low-noise amplifier when the wake-up signal is detected,
wherein the controller controls the first switch and the second switch such that the antenna is connected to the low-noise amplifier and the wake-up signal detector in the sleep mode; that the antenna is connected to the low-noise amplifier and the receiver in the Rx mode; and the antenna is connected to the transmitter in the Tx mode.

9. A low-power wireless communication method comprising the steps of:
receiving and amplifying an RF signal at a predetermined on-off duty ratio in a sleep mode corresponding to an Rx waiting state;
detecting a wake-up signal from the amplified RF signal;
determining the validity of the wake-up signal;
transmitting the RF signal if the wake-up signal is valid; and
switching to the sleep mode after completion of the transmission/reception of the RF signal.

10. The low-power wireless communication method of claim 9, further comprising the step of setting the predetermined on-off duty ratio depending on communication environments.

11. The low-power wireless communication method of claim 9, wherein the step of detecting the wake-up signal from the amplified RF signal comprises the steps of:
detecting the wake-up signal;
rectifying the amplified RF signal;
integrating the rectified RF signal; and
comparing the integrated RF signal with a predetermined threshold point.

12. The low-power wireless communication method of claim 9, wherein the validity of the wake-up signal is determined by receiving data after the detection of the wake-up signal.

13. The low-power wireless communication method of claim 9, further comprising the step of switching to the sleep mode if the wake-up signal is invalid.

14. The low-power wireless communication method of claim 9, further comprising the step of switching to an off mode where an off state is maintained during a predetermined time before the switching to the sleep mode.

15. The low-power wireless communication method of claim 12, further comprising the step of switching to an off mode where an off state is maintained during a predetermined time before the switching to the sleep mode.
